(19) United States
(12) Patent Application Publication
(10) Pub. No.: US 2023/0313832 A1
(43) Pub. Date: Oct. 5, 2023

(54) HYDRAULIC BEARING BUSH

(71) Applicant: ContiTech Luftfedersysteme GmbH, Hannover (DE)

(72) Inventors: Andre Sanz, Hamburg (DE); Sara Grotsch, Hamburg (DE)

(73) Assignee: ContiTech Luftfedersysteme GmbH, Hannover (DE)

(21) Appl. No.: 18/044,007

(22) PCT Filed: Aug. 30, 2021
(86) PCT No.: PCT/DE2021/200116

§ 371 Date: Mar. 3, 2023

(30) Foreign Application Priority Data
Sep. 4, 2020 (DE) 10 2020 211 184.7

(51) Int. Cl. F16C 17/02

(52) U.S. Cl. CPC F16C 17/026

(57) ABSTRACT

A hydraulic bearing bushing (1) having:—an annular rubber body (3) that comprises an inner bushing (2) for receiving a bearing journal (12),—an outer annular housing (6) against the inner circumference of which the annular rubber body is supported, —at least two chambers (7, 8) that are formed between the annular rubber body and the annular housing or within the rubber body, are able to be filled with a hydraulic fluid and are connected together via at least one equalizing and throttle channel (9) such that, when the inner bushing is loaded by bearing forces, hydraulic fluid is exchangeable between the chambers. Reinforcing members (13, 14) having a greater modulus of elasticity in relation to the rubber material are arranged in or on the annular rubber body such that, when there is a pressure increase in one of the chambers, an expansion of the rubber body corresponding to an inflation or a change in shape is able to be reduced at least in one direction.

The invention relates to a hydraulic bearing bushing which has the following features:
a preferably two-part inner bushing for receiving a bearing journal,
an annular rubber body that at least partially encloses the inner bushing radially on the outside and/or axially on the outside and is connected thereto by vulcanization,
an outer annular housing against the inner circumference of which the annular rubber body is supported axially and radially on the outside, and
at least two chambers that are formed in the circumferential direction between the annular rubber body and the annular housing or within the rubber body, each extend over partial regions of the circumference and are able to be filled with a hydraulic fluid,
   wherein the chambers are connected together via at least one equalizing and throttle channel such that, when the inner bushing is loaded by bearing forces, hydraulic fluid is exchangeable between the chambers.

Hydraulic bearing bushings of this kind for influencing and/or setting the damping characteristics of bearings on vehicles, in particular rail vehicles, are already known in various designs. Such bearing bushings are used for the elastic mounting of movable parts such as the parts of a running gear of a vehicle, in particular of a rail vehicle, and are also referred to here as “wheelset guide bushings”.

As a rule, such a bearing bushing in the form of a rubber-metal bearing consists of an internal rubber-metal element which is received in a metal sleeve. The outer metal sleeve is connected for example to the body of the vehicle, while the internal rubber-metal element receives a journal that is fastened to the running gear. In a wheelset guide bushing in train chassis, the journal or pin is connected to the bogie frame, while the outer metal sleeve is mounted in the primary yoke.

Arranged between the elastomeric part/rubber part of the rubber-metal element and the metal sleeve as housing element are chambers that extend over partial regions of the circumference and are able to be filled with a hydraulic fluid, said chambers often being formed in a kidney-shaped manner over a partial circumference of the bearing. These fillable chambers are connected together or to an equalizing chamber by at least one connecting channel. Depending on the design, these hydraulic chambers can also be arranged entirely in the rubber part of the rubber-metal element.

When the hydraulic bushing is loaded, the compression of the rubber part reduces the size of one chamber, such that a part of the hydraulic fluid in the chamber flows through the connecting channel into the other chamber or into an equalizing chamber. The connecting channel then acts as a hydraulic throttle, in other words as a throttle channel. The flow through the correspondingly formed throttle channel generates dissipation and therefore damping work.

A hydraulic fluid is therefore provided in chambers that are surrounded at least partially by the rubber-elastic material, for instance in chambers arranged diametrically opposite one another, to provide further vibration-damping characteristics. Here, the connecting channel, with its throttle characteristic, serves as a vibration damper or to provide dynamic stiffness in a corresponding direction of loading.

DE 103 10 633 A1 discloses one such bearing bushing. Said document describes a bushing for a bearing for the elastic connection of parts of a running gear. The bushing, which is intended in particular for rail vehicles, has an inner housing about which an outer housing is provided in a radially spaced-apart manner to form an annular gap. Located in the annular gap is a rubber-elastic element, which delimits two diametrically opposite chambers, which are filled with a hydraulic fluid and are connected together via an overflow channel in the form of a vibration damper.

The damping characteristics of such hydraulic bushings are frequency-dependent on account of their design. Usually, low-frequency vibrations, i.e. vibrations with frequencies of less than about 2 Hz, which generally occur with amplitudes of about 10 mm, are damped to a great extent, while high-frequency vibrations, i.e. vibrations in the frequency range above said value, are damped much less on account of the inertia and incompressibility of the hydraulic fluid and the rubber spring. These characteristics have been exploited hitherto in that, through the configuration of the connecting channel, i.e. through the diameter and length thereof, the damping and dynamic stiffness can be set in a frequency-dependent manner. Attempts have been made here to achieve a high dynamic stiffness by way of a small channel cross section, with a simultaneously high inflation stiffness of the rubber body. When traveling at high speed and in the case of a brief sequence of irregularities on the rail and resultant mechanical shocks in the process, such high stiffness and hard mounting are required in order to ensure safety even when traveling at high speeds.

On the other hand, for instance when traveling around bends, in the case of low-frequency shocks or with virtually static loads, mounting that is as soft as possible is intended to be achieved. Such “soft” stiffness is achieved, however, only with a correspondingly soft rubber body. With a soft rubber body, however, high inflation stiffness of the hydraulic chambers delimited at least partially by the rubber body cannot be achieved. This thus results in a classic conflict of objectives, wherein the desire for soft mounting in the vehicle longitudinal direction conflicts with the provision of the required travel safety.

This is where the present invention takes effect. Specifically, the present invention is based on the object of mitigating the abovementioned conflict of objectives and to increase the inflation stiffness of such mountings with approximately unchanging characteristics and soft mounting at particular static loads or low frequencies. The object is thus to design the generic bearing bushing such that, in the low frequency range, soft stiffnesses can be realized and at defined higher frequencies, high stiffnesses in the direction of travel can be realized, wherein, moreover, favorable production through the use of favorable materials, simple designs and simple production processes is intended to be achieved. The hydraulic wheelset guide bushing is intended to realize soft stiffnesses at low frequency and high stiffnesses at higher frequencies.

The object is achieved by the features of the main claim. Advantageous developments are contained in the dependent claims. The invention also discloses a rail vehicle running gear having the hydraulic bearing bushing according to the invention as wheelset guide bushing.

In this case, reinforcing members having a greater modulus of elasticity in relation to the rubber material are arranged in or on the annular rubber body such that, when there is a pressure increase in one of the chambers, an expansion of the rubber body corresponding to an inflation or a change in shape is able to be reduced at least in one direction, preferably able to be reduced in the direction of travel.

The modulus of elasticity E is all the greater, the lower the deformation E that a specimen of a material undergoes under a particular load. In the linear region, this relationship is described approximately by Hooke's law, wherein σ=E·∈ (where a is the stress in N/mm²).

Here, the reinforcing members can be arranged specifically in or on the rubber body, and the hydraulic bearing bushing according to the invention can be designed, such that, at low-frequency excitations, for example when traveling around bends or through points, the wheel adapts to the rail, in accordance with the soft longitudinal stiffness, with low opposing forces and thus low wear and quietly. Such “softness” in the longitudinal direction does not necessarily have anything to do with comfort, but rather reduces the wear between the wheel and rail as well as the noise emission. In some countries, wheel-rail wear, for example, is calculated and ascertained by measurements. This calculation also contains, inter alia, the longitudinal stiffness of the primary spring stage embodied here, inter alia, with the hydraulic wheelset guide bushing. In contrast thereto, however, the running stability is intended to be increased by the hardness in the longitudinal direction, which increases with frequency.

In the case of low-frequency shocks or vibrations, the desired soft mounting is thus achieved, while at high-frequency loads, for instance when traveling at high speed and thus in the case of a brief sequence of irregularities on the rail, a stiffness is achieved, namely a high stiffness, required for travel safety, in the direction of travel. Thus, as a result of the adapted and direction-dependent introduction of reinforcing members into the rubber body, the inflation stiffness of the latter is increased specifically in the desired regions and thus the abovementioned conflict of objectives is mitigated considerably. Tests have shown that a large spread is possible between static and dynamic stiffness, wherein a ratio of static to dynamic stiffness of 1:15 was achieved.

In an advantageous development, the reinforcing members are connected to the annular rubber body by vulcanization. This results in simple incorporation of the reinforcing members even during the production of the bearing bushings according to the invention. Particularly in such bearing bushings, from a design point of view, a further configuration can advantageously be realized, which consists in that the reinforcing members are annular or helical.

In a further advantageous configuration, reinforcing members made of a metal material, preferably in the form of steel cords or steel rings, are arranged in or on the annular rubber body. Steel cords or steel rings can be produced in any way and adapted to their use.

In a further advantageous configuration, reinforcing members made of a plastics material are arranged in or on the annular rubber body. Plastics materials can also be integrated easily in the rubber material during the production of the bearing bushings. Vulcanization within the rubber material is equally possible, as is adhesion to the rubber material.

In a further advantageous configuration, reinforcing members made of a fiber material, preferably made of Kevlar fibers, glass fibers or carbon fibers, are arranged in or on the annular rubber body. In such a configuration, not only is it possible to produce the reinforcing members by winding, in particular in the case of the abovementioned “round” bearing bushings, but it is also possible to produce any desired structures from the fiber materials. This can take place for example in the form of a further advantageous configuration, which consists in that the reinforcing members are in the form of a mesh or fabric provided in or on the annular rubber body.

In a further advantageous configuration, two support rings vulcanized onto the two axially outer ends of the rubber body, preferably support rings made of metal, are provided, wherein the rubber body is supported axially and radially against the inner circumference of the outer annular housing via the support rings, preferably in the two end regions of the annular housing. According to the invention, at least two metal rings are provided as reinforcing members, which are vulcanized onto the inner circumference of the rubber body between the axial ends of the inner bushing and the support rings. Such embodiments with metal support rings on the two sides or at the two ends of the rubber body are required for example for the use of bearing bushings as wheelset guide bushings when used in rail vehicle running gears.

In a further advantageous configuration, the reinforcing members in the form of metal rings are arranged at least partially within the rubber body. This results in both a secure fit of the reinforcing members and production that is not too complicated.

Hydraulic bearing bushings of the type according to the invention can be used readily in particular in rail vehicle running gears, in this case as wheelset guide bushings. In such rail vehicle running gears, it is important that different stiffnesses can be formed in different directions, as already set out above.

The invention will be explained in more detail on the basis of an exemplary embodiment.

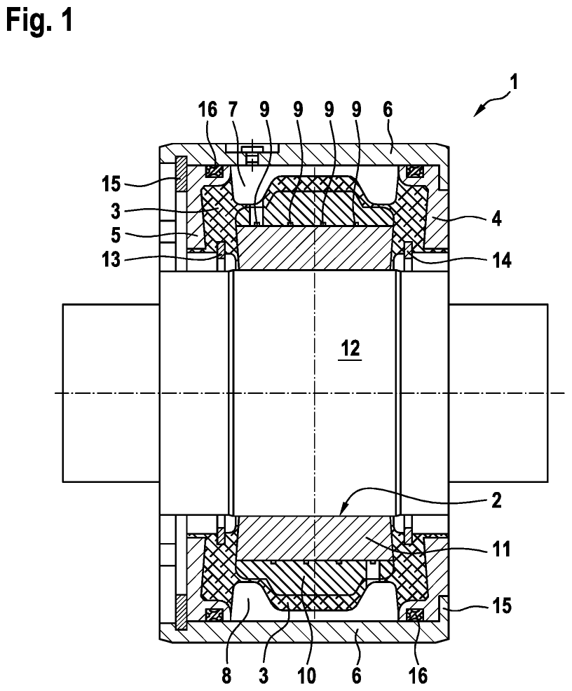

FIG. 1 schematically shows a hydraulic bearing bushing 1 for a rail vehicle running gear (not illustrated in more detail here). The hydraulic bearing bushing has an inner bushing 2 for receiving a pin or bearing journal 12, which serves for connecting to the bogie frame. The hydraulic bearing bushing also has an annular rubber body 3 that partially encloses the inner bushing 2 radially on the outside and axially on the outside and is connected thereto in these enclosure regions by vulcanization. The embodiment of the bearing bushing shown here also has two annular, metal support rings 4 and 5 vulcanized onto the two axial ends of the rubber body.

The hydraulic bearing bushing furthermore has an outer annular housing 6 against the inner circumference of which, specifically at the two axial ends of the housing, the support rings 4 and 5 are fixed by corresponding securing means/securing rings 15 and are sealed off toward the outside by sealing rings 16. The support rings 4 and 5 serve to reliably absorb particularly high axial loads and to transmit them from the bearing housing 6 to the inner bushing 2 via the rubber body 3. In the case of less high axial loads in other fields of application than in train running gears, designs without such support rings are quite conceivable, in which for instance all axial loads are transmitted by the vulcanization connection between the rubber body, housing and inner bushing.

FIG. 1 likewise shows that the hydraulic bearing bushing 1 has two chambers 7 and 8 that are formed in the circumferential direction between the annular rubber body 3 and the annular housing 6, each extend over partial regions of the circumference and are able to be filled with a hydraulic fluid, said chambers being connected together via equalizing and throttle channels 9. The direction of travel lies in this case in the plane of the drawing and the hydraulic chambers are deformed to a greater or lesser extent by radial forces, acting in the plane of the drawing, during operation of the bearing bushing, such that the hydraulic fluid located therein can flow into the respectively other chamber via the equalizing and throttle channel 9.

To simplify the production of the equalizing and throttle channels 9, the inner bushing 2 consists here of two hollow-cylindrical bodies inserted coaxially one in the other, specifically of a metal bushing 11 provided with an outer sleeve 10 made of steel. The equalizing and throttle channel 9 is in this case configured as a recess in the inner surface of the sleeve 10 and extends helically along a partial length of the inner bushing. The equalizing and throttle channel 9 is thus formed substantially in the connecting region or contact region of the steel sleeve 10 and metal bushing 11.

The inner bushing 2, or in this case the outer sleeve 10 of the inner bushing 2, to this end has, of course, corresponding inflow bores which connect the respective channel start to the corresponding chambers. The rubber body 3 also has corresponding inflows and bores that correspond to the inflow bores, of course.

The present configuration of the bearing bushing now consists in that reinforcing members 13, 14 in the form of steel rings are arranged partially within the rubber body 3 and have been vulcanized in. The steel rings, having a modulus of elasticity that is much higher relative to the rubber material, prevent, as a result of their arrangement on the inner circumference of the rubber body 3 and between the axial ends of the inner bushing 2 and the support rings 4, 5, any inflation of the rubber body 3 in the direction of the bearing middle in the event of a pressure rise in one of the chambers 7, 8. As a result of such high inflation stiffness, provided according to the invention, of the rubber body, the dynamic stiffness is then dependent substantially on the configuration of the connecting channel 9, i.e. on the diameter and length thereof. When traveling at high speed and in the case of a high frequency of the load, a high stiffness and hard mounting are required in order to ensure the travel safety.

A certain softness of the bearing bushing in the axial direction is retained, however, even in the present design with reinforcing members. In this regard, the conflict of objectives described at the beginning is solved to a satisfactory degree by the configuration according to the invention with reinforcing members. Low static stiffness in the vehicle longitudinal direction can be realized only with soft rubber and the latter by its nature does not have high inflation stiffness. For this purpose, the reinforcing members are then provided according to the invention.

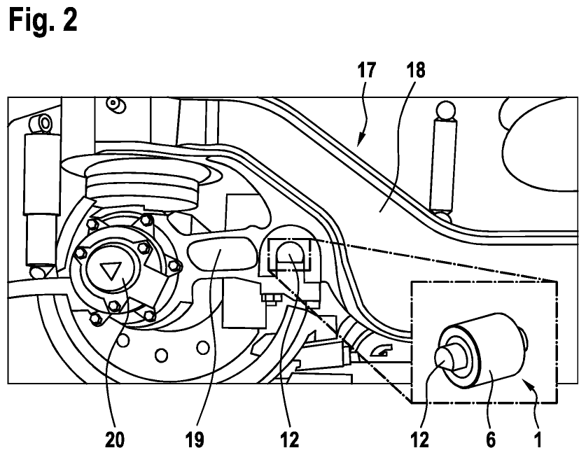

For better understanding, FIG. 2 shows once, in a perspective diagram, an application or the use of a wheelset guide bushing in the rail vehicle running gear of a train chassis 17. The journal or pin 12 enclosed by the inner bushing or by the two hollow-cylindrical bodies inserted coaxially one in the other is connected to the bogie frame 18, while the outer housing 6—visible here only in the exploded illustration—is mounted in the primary yoke 19, in which the wheelset 20 is received.

### LIST OF REFERENCE SIGNS

(Part of the description)

1 Bearing bushing/wheelset guide bushing

2 Inner bushing

3 Annular rubber body

4 Metal support ring

5 Metal support ring

6 Outer annular housing

7 Hydraulic chamber

8 Hydraulic chamber
Equalizing and throttle channel between the hydraulic

9 chambers

10 Outer steel sleeve of the inner bushing

11 Metal bushing (inner bushing)

12 Bearing journal

13 Vulcanized-in reinforcing member (steel ring)

14 Vulcanized-in reinforcing member (steel ring)

15 Securing ring/securing means

16 Sealing ring

17 Train chassis

18 Bogie frame

19 Primary yoke

20 Wheelset

1.-10. (canceled)

11. A hydraulic bearing bushing comprising:
an inner bushing for receiving a bearing journal;
an annular rubber body that at least partially encloses the inner bushing radially on an outside and is vulcanized in enclosure regions;
an outer housing against an inner circumference of the annular rubber body that is supported axially and radially on an outside;
two chambers formed in a circumferential direction between the annular rubber body and the outer housing, each extend over partial regions of the circumference and are fillable with a hydraulic fluid;
the two chambers are connected by an equalizing and throttle channel and configured to exchange the hydraulic fluid between the two chambers when the inner bushing is loaded by bearing forces; and
reinforcing members having a greater modulus of elasticity than the annular rubber body, connected to the annular rubber body, and arranged so that an expansion of the rubber body corresponding to an inflation is reduced or prevented in a direction of travel on a pressure increase in the two chambers.

12. The hydraulic bearing bushing of claim 11, wherein the reinforcing members are connected to the annular rubber body by vulcanization.

13. The hydraulic bearing bushing of claim 11, wherein the reinforcement members are annular or helical.

14. The hydraulic bearing bushing of claim 11, wherein the reinforcing members are made of a metal material in the form of steel cords or steel rings, are arranged in or on the annular rubber body.

15. The hydraulic bearing bushing of claim 11, wherein the reinforcing members comprise a plastics material are arranged in or on the annular rubber body.

16. The hydraulic bearing bushing of claim 11, wherein the reinforcing members made of a fiber material and are arranged in or on the annular rubber body.

17. The hydraulic bearing bushing of claim 11, wherein the reinforcing members are in the form of a mesh or fabric provided in or on the annular rubber body.

18. The hydraulic bearing bushing of claim 11, further comprising two support rings vulcanized onto the two axially outer ends of the rubber body.

19. The hydraulic bearing bushing of claim 18, the support rings made of metal, wherein the rubber body is supported axially and radially against the inner circumference of the outer annular housing via the support rings.

20. The hydraulic bearing bushing of claim 19, wherein the reinforcing members in the form of metal rings are arranged at least partially within the rubber body.

21. The hydraulic bearing bushing of claim 11, the bushing formed as a wheelset guide bushing for a train chassis.
